(19) United States
(12) Patent Application Publication
(10) Pub. No.: US 2008/0036920 A1
(43) Pub. Date: Feb. 14, 2008

(54) MULTIMEDIA PROJECTOR

(76) Inventor: CHUAN-CHAO TSENG, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/835,737

(22) Filed: Aug. 8, 2007

(30) Foreign Application Priority Data
Aug. 9, 2006 (TW) 95214045

(51) Int. Cl. H04N 9/31

(52) U.S. Cl. 348/744; 348/E09.025

(57) ABSTRACT

A multimedia projector includes a base and a projection optical device. The base comprises an optical disc drive to read an optical disc. A hinge joins the base and the projection optical device such that the projection optical device swivels with relation to the base. A projection lamp is disposed inside the hinge to provide an illumination for the projection optical device.

### RELATED APPLICATIONS

This application claims priority to Taiwan Application Serial Number 95214045, filed Aug. 9, 2006, which is herein incorporated by reference.

### BACKGROUND

1. Field of Invention

The present invention relates to a multimedia projector.

2. Description of Related Art

Nowadays, story telling seems a necessary task when parents tuck their children into bed. Story telling can be done in various ways depending on what the parents and children want. Some parents may read a storybook out loud for their children; others may act the principal character of the storybook. It seems all right for the former case if children can listen to the stories quietly. It may be harder for most parents in the latter case.

In order to enable every parent to satisfy his or her children's story listening needs, there is a need for designing a storytelling device.

### SUMMARY

A multimedia projector includes a base and a projection optical device. The base comprises an optical disc drive to read an optical disc. A hinge joins the base and the projection optical device such that the projection optical device swivels with relation to the base. A projection lamp is disposed inside the hinge to provide an illumination for the projection of the optical device.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a multi-media projector according to one embodiment of this invention;

FIG. 2 illustrates a copyright protector and an optical disc therein according to one embodiment of this invention;

FIG. 3 illustrates a copyright protector and an optical disc therein according to another embodiment of this invention;

FIG. 4 illustrates an optical disc in FIG. 2 and FIG. 3.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

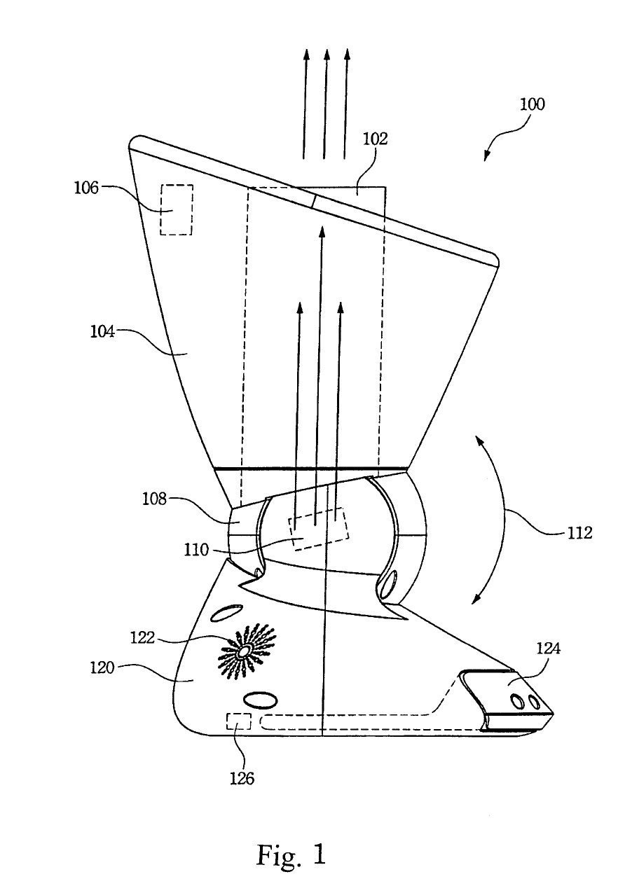

FIG. 1 illustrates a multimedia projector according to one embodiment of this invention. A base 120 of the multimedia projector 100 includes an optical disc drive 124 to read an optical disc. A projection optical device 102 of the multimedia projector 100 displays the content (motion picture) contained in the optical disc on any proper flat surface, i.e. a white paper or a bedroom ceiling. The optical disc drive 124 can be pulled out for loading or replacing an optical disc. The projection optical device 102 is pivotally connected with the base 120 by a hinge 108 such that the projection optical device 102 can swivel along a direction 112 in relation to the base 120 to project images to a desired place. For instances, when the projection optical device 102 is adjusted upright (as illustrated in FIG. 1), the projection optical device 102 can project images to a bedroom ceiling. A housing 104 is designed to enclose the projection optical device 102. A night lamp 106 may be added inside the housing 104 such that the multimedia projector 100 can serve as a bedroom illumination when its multimedia display function is idle.

The projection optical device 102 can be any conventional projection optical device plus a projection lamp 110 with a proper light out. The light out of the projection lamp 110 is decided according to heat dissipation ability of the multimedia projector 100. When the multimedia projector 100 serves as a storytelling device to operate an optical disc, the light out of the projection lamp 110 is less than that of a projector used in the office. Even if the light out of the projection lamp 110 is smaller, a heat dissipation device is still essential inside the hinge 108. The heat dissipation device, such as a fan, can be installed in the base 120 or hinge 108 and adjacent to the projection lamp 110.

The multimedia projector 100 outputs not only images but also music and sounds. A speaker (not illustrated) can be installed in the base 120 and is adjacent to a plurality of sound holes 122 to output music and sounds contained in the optical disc.

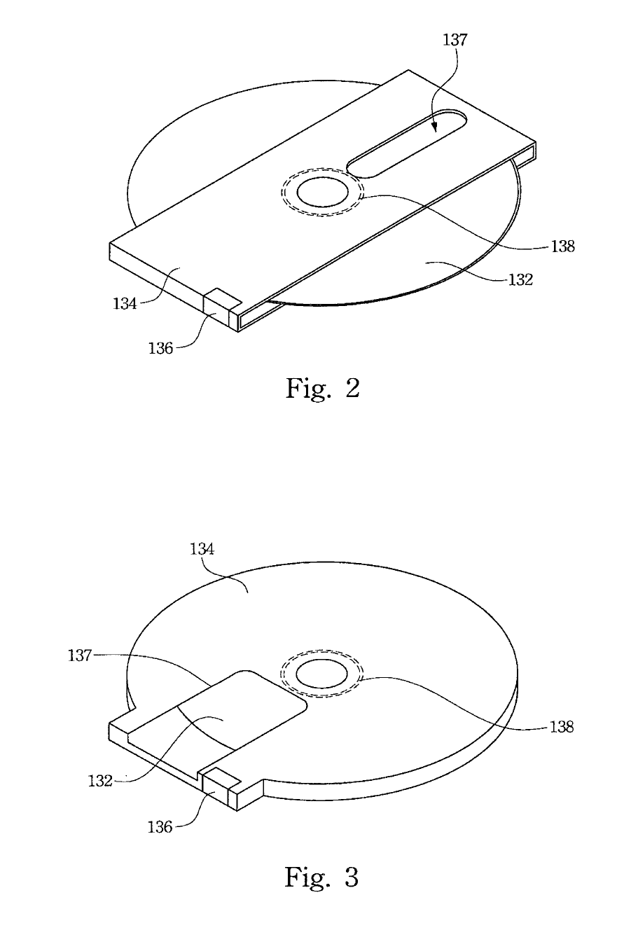

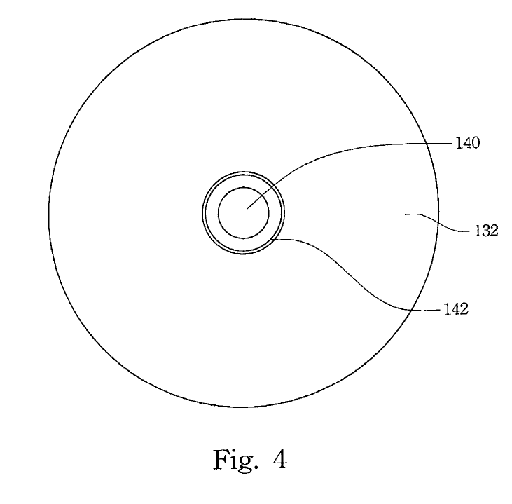

FIG. 2 and FIG. 3 respectively illustrate two types of copyright protectors according this invention, wherein FIG. 2 illustrates a copyright protector partially enclosing the optical disc; and FIG. 3 illustrates a copyright protector completely enclosing the optical disc. FIG. 4 illustrates an optical disc in FIG. 2 and FIG. 3.

In order to protect content copyright of the optical disc authorized in the multimedia projector 100, a copyright protection mechanism is utilized. A copyright protector 134 is used to enclose an optical disk 132. The copyright protector 134 includes an identification 136 such that an identification reader 126 of the multimedia projector 100 (illustrated in FIG. 1) can read the identification 136 to decide whether the optical disc contained in the copyright protector 134 is valid or not. The identification 136 located on the copyright protector 134 where the identification reader 126 can properly read. Before the optical disc drive 124 reads the optical disc contained in the copyright protector 134, the identification reader 126 verifies if the authorization is valid or not. Therefore, copyright protection can be achieved.

An opening 137 is formed on the copyright protector 134 and corresponds to a pick-up head (not illustrated) of the optical disc drive 124 such that the pick-up head can read the optical disc 132 through the opening 137. In addition, a rotation ring 138 is formed on the copyright protector 134 and a rotation ring 142 is formed on the optical disc 132. The rotation ring 138 engages with the rotation ring 142, i.e. the rotation ring 138 is a concave section and the rotation ring 142 is a convex section, such that the optical disc 132 can be rotatably connected with the copyright protector 134. When the copyright protector 134 containing the optical disc 132 loads into the optical disc drive 124, the optical disc 132 can be rotatably driven (with relation to the copyright protector 134) by its circular hole 140 and the pick-up head can also read the optical disc 132 through the opening 137.

According to embodiments of this invention, the multimedia projector 100 can provide parents a different and vivid way to accompany their children on the bed. For a content provider (or story provider), the multimedia projector 100 can provide a copyright protection mechanism to protect story content.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multimedia projector, comprising:
a base, comprising an optical disc drive to read an optical disc;
a projection optical device;
a hinge, joining the base and the projection optical device such that the projection optical device swivels with relation to the base; and
a projection lamp, disposed inside the hinge to provide an illumination for the projection optical device.

2. The multimedia projector of claim 1, further comprising a housing enclosing the projection optical device.

3. The multimedia projector of claim 2, further comprising a night lamp inside the hosing.

4. The multimedia projector of claim 1, further comprising a copyright protector enclosing the optical disc.

5. The multimedia projector of claim 1, further comprising a copyright protector partially enclosing the optical disc.

6. The multimedia projector of claim 4, wherein the copyright protector comprises an opening to expose the optical disc inside thereof, and the optical disc drive reads the optical disc through the opening.

7. The multimedia projector of claim 5, wherein the copyright protector comprises an opening to expose the optical disc inside thereof, and the optical disc drive reads the optical disc through the opening.

8. The multimedia projector of claim 4, further comprising an identification reader disposed in the optical disc drive.

9. The multimedia projector of claim 8, wherein the copyright protector comprises an identification, when the copyright protector enclosing the optical disc is loaded into the optical disc drive, the identification reader reads the identification of the copyright protector.

10. The multimedia projector of claim 5, further comprising an identification reader disposed in the optical disc drive.

11. The multimedia projector of claim 10, wherein the copyright protector comprises an identification, when the copyright protector enclosing the optical disc is loaded into the optical disc drive, the identification reader reads the identification of the copyright protector.
